(19) United States
(12) Patent Application Publication
(10) Pub. No.: US 2009/0176010 A1
(43) Pub. Date: Jul. 9, 2009

(54) Method of manufacturing organic light emitting display

(76) Inventors: Lucy M. Zwick, Doylestown, PA (US); Eugene Zwick, Doylestown, PA (US); Oleksandr Lukhanin, Philadelphia, PA (US); Rouvim Tsvyk, Tomsk (RU); Andrey Lezhennikov, Moscow (RU)

Correspondence Address: Lucy M. Zwick;Eugene Zwick, 6086 Carversville Rd., Doylestown, PA, 18902, US

(21) Appl. No.: 12/006,577

(22) Filed: Jan. 4, 2008

(51) Int. Cl. B05D 5/12

(52) U.S. Cl. 427/78

(57) ABSTRACT

Method of multilayer thermal vacuum deposition of different materials on a substrate can be done within a 45 minute-production cycle, in the vacuum chamber with custom design, and contributes to a complete deposition of organic and metal materials without its reloading in the course of the deposition.

### CROSS REFERENCE TO RELATED APPLICATIONS

Reference is made to commonly assigned U.S. patent application Ser. No. 407840 filed Apr. 20, 2006, by Tyan; Yuan-Sheng; (Webster, N.Y.); Long; Michael; (Hilton, N.Y.), Phelan; Giana M.; (Rochester, N.Y.); Cushman; Thomas R.; (Rochester, N.Y.) Michael Long et al, entitled “Vapor deposition of a layer”, Russian patent application Ser. No. 2002105015/06 filed Aug. 27, 2003, by MAGEhN Paskal' (BE), UINAN Rene (BE), entitled Electro-luminescent device and method for its manufacture, U.S. patent application Ser. No. 275318 filed Mar. 11, 2002, by Takeo; Kawase (Cambridge, GB), entitled “Method of patterning a substrate”, U.S. patent application Ser. No. 470513 filed Dec. 22, 1999, by Utsugi; Koji (Tokyo, JP); Saitoh; Takeshi (Tokyo, JP); Tamegai; Masashi (Tokyo, JP), entitled “Method of manufacturing organic thin-film EL device”, U.S. patent application Ser. No. 812703 filed Dec. 23, 1985, by Abdalla; Mohamed I. (Neptune, Beverly, Mass.); Miller; M. Robert (Neptune, N.J.), entitled “Method for patterning transparent layers on a transparent substrate.”

### FIELD OF THE INVENTION

Present invention relates to a method of making thin film organic light emitting diode display and, more particularly, to a vacuum deposition method of producing electroluminescent films and devices which are operable at low voltages. Electroluminescent devices which can be operated at low voltage are useful because of their compatibility with integrated circuit devices. Furthermore, such devices can be operated via batteries without any hazard associated with higher operating voltages.

### BACKGROUND OF THE INVENTION

Electroluminescent organic light emitting diode (OLED) devices are based on the ability of certain organic materials to transform electrical energy into light. Electroluminescence is not energetic enough to ionize atoms and generate light in a full spectrum without heat loss. Various phosphor materials have been added to manufacture OLEDs displays. Moreover, various methods have been utilized to fabricate electroluminescent devices. Thornton, Journal of Applied Physics, Volume 33, pp. 3045-3048, 1962, and later Plumb, Japanese Journal of Applied Physics, Volume 10, pp. 326-331, March 1971, evaporated ZnS: Mn, Cu, Cl phosphor materials, on a glass substrate coated with tin oxide or indium-tin oxide. Abdalla and Thomas, Proceedings of the S.I.D., volume 19/3, pp. 91-95, 1978, prepared films of ZnS:Mn, Cu by evaporating Zn, S, Mn, and Cu onto a tin oxide or indium-tin oxide coated glass substrate from separate sources.

Organic material—small molecules are deposited on substrate by vacuum deposition. The small molecule approach is based on the patents of Tang and Van Slyke of Eastman Kodak and their licensees. Small molecule—is an ideal film for organic electroluminescent devices (OLED) applications. Microcrystalline structure of the small molecule influences the morphology of a film to promote the formation of crystal packing. One manufacturing challenge is the sensitivity of the organic matter used in the display to moisture and oxygen. These can quickly destroy OLED displays (Vitex Frost & Sullivan). Inoue of Epson said that the future of OLED displays will depend not on materials, polymer vs. small-molecule, but on the selection of manufacturing methods.

OLEDs are fabricated on a transparent glass substrate where the first electrode-indium-tin-oxide (ITO), being used as an anode contact and hole injector layer, is first deposited. ITO is by no means an ideal anode; however, ITO is responsible for device degradation as a result of Indium diffusion into the OLED, eventually causing short circuits as identified by G. Sauer et al., Fresenius J. Anal. Chem., pp. 642-646, vol. 353 (1995). ITO is polycrystalline and its abundance of grain boundaries provides ample pathways for contaminant diffusion into the OLED. Finally, ITO is a reservoir of oxygen which is known to have a detrimental effect on many organic materials (see J. C. Scott, J. H. Kaufman, P. J. Brock, R. DiPietro, J. Salem, and J. A. Goita, J. Appl. Phys., Vol. 79, p. 2745, 1996). Despite all these problems, ITO anodes are favored because no better transparent electrode material is known and ITO provides adequate stability for many applications.

Patterning of film is required to achieve high-resolution full color displays. For small-molecule type OLED's, the pixel patterns are formed by using shadow masks. “As the mask is very thin, it is difficult to make a large mask. Several-inch diagonal will probably be the limit,” said Kanzaki (Toshiba).” Sony intends to introduce large OLED panels (over 13-inch) using small-molecule materials and evaporation methods. “Sure, it is difficult to make a large mask. But it is an exciting challenge.” In spite of polymer OLED's having the cost advantage for lighting devices, a greater operational lifetime of 10,000 hours gives small molecules priority over light-emitting polymers in the general lighting market, where most applications need lifetimes of more than 20,000 hours.

Process, called vacuum thermal deposition is chosen because organic materials are small molecules and organic-metallic materials. During this process, thickness of the film can be controlled at the level of one layer of atoms to be deposited at a time. The total thickness of the organic layers is ˜60 nm. The metal cathode (Aluminum and Calcium) is evaporated on top. These metals are chosen to provide efficient injection of electrons. The two electrodes add perhaps ˜60-70 nm more to the total thickness of the device. Therefore the overall thickness (and weight) of the structure is mostly due to the substrate itself. Multilayer structures with a few nanometers in thickness are needed to achieve the high performance of OLED devices.

Value degree and integrity of electroluminescent device depend on bonds between the metals-metals and the metals-organic materials. The bonding and ordering of molecules on surfaces are generally controlled by balance between the competing molecule-molecule and molecule-substrate interactions. Aluminum (Al) reacts aggressively to organic materials. Calcium (Ca), in contrast with Al, has low electron binding energy and is not aggressive to organic layers. Moreover, as a mineral ionic supplement, Calcium is responsible to form strong bonds with organic molecules to generate metal-chelate complexes, which have qualities different than those of the mineral itself. The type of bonding between the Calcium metal and an organic molecule creates a stable compound.

Deposition process occurs in the vacuum chamber in one completed production cycle for all materials. It protects them from being saturated by atmospheric gases, moisture, and active solvents. However, interaction of oxygen-moisture-temperature-sensitive materials during vacuum deposition process could decrease life time of device. In order to improve performance, Forrest et al. believed that by using their tandem OLED structure, full color emission devices with higher integrated density in the display can be made. Nevertheless, each OLED unit in its devices needs a separate power source.

Report has been made about a display-prototype of an organic thin-film EL display having multi-color as application of the organic thin-film EL device. High efficiency was achieved for the following OLED structure: ITO/hole-injecting layer/electron transporting layer/cathode. Also the voltage of about 5-12 volts is sufficient to drive enough current to cause a very bright emission, which is less expensive than other manufacturing processes. Furthermore, the lifetime of the organic thin-film EL device prototype and performance for a practical use have been accomplished by improving a device structure or device material, although not sufficient. In order to improve the luminous efficiency of the OLED device, the device structure and the electrical properties of the material used must be optimized and qualitatively cleared. example, an electron (hole) transportation property, an electron (hole) injection property, a donor type, an acceptor type, and a light emission property have to be defined.

Considerable improvements were achieved using different aromatic structures as a luminescent complex with electron transporting properties. Such methods are well known, for example Barr in U.S. Pat. No. 2,447,789 and Tanabe et al. in EP 0 982 411. The organic materials used in the manufacture of OLED devices are often subject to degradation when maintained at or near the desired rate for extended periods of time. Exposure of sensitive materials to higher temperatures can cause changes in the structure of the molecules and associated changes in material properties.

### SUMMARY OF THE INVENTION

Object of the present invention is manufacturing multilayered organic light emitting diode display where materials are oxygen-moisture-temperature-sensitive;

Object is achieved by the method of multilayer vapor thermal deposition on a substrate of the above-mentioned materials, within 45 minute-production cycle, without reloading organic and metal materials;

A further advantage of the present invention said that one completed deposition cycle increases capability for depositing thin film in large quantities with low cost production; reduces possibility of contamination and protects cathode and organic materials from oxygen/moisture degradation. Adequate interlocking system without reloading materials during deposition precludes oxygen/moisture degradation of cathode and organic materials and increases life time and brightness of device;

A further advantage of the present invention is the method of vapor thermal deposition, where number of apertures of common screen is equal is equal to a number of thermal evaporators, while a number of apertures of common screen is equal to a number of masks that allows molecules of different materials from thermal evaporators to reach the substrate without colliding with gas molecules in space between the thermal evaporation source and substrate;

A further advantage of the present invention is the method of manufacturing multilayered organic light emitting diode display, which provides first material comprising a transparent glass substrate, based on SiO₂, B₂O₃, and Al₂O₃ materials that can be used in high temperature applications and no passivated layer is present between ITO and glass substrate;

It's further advantage of the present invention that the method of manufacturing multilayered organic light emitting diode display provides small organic molecule-compound of polycyclic aromatic hydrocarbons, of total thickness ˜17.5 nm and is favorable to the above mentioned structure, to its luminance and brightness and, ultimately, to reduction of expenses and time required for device manufacturing;

It's further advantage of the present invention that the method of manufacturing multilayered organic light emitting diode display provides cathode materials, Ca, neutral to organic materials reciprocity and Al, protecting Ca from moisture and oxygen degradation;

it's a further advantage of the present invention that the method of manufacturing multilayered organic electroluminescent device provides Ca and Al, evaporated from different boats in order to increase luminescence and brightness. Also, it reduces expenditures required for organic electroluminescent device manufacturing due to the fact that costly process of cathode alloy manufacture is no longer relevant;

It's a further advantage of the present invention that the method of manufacturing multilayered organic light emitting diode display provides best performance of the device at U—5V under 40 lux and U—6V under 3600 lux;

A further advantage of the present invention said, that technique of substrate surface preparation is provided to pattern film in order to change surface properties that interfere with the film formation process and affect the film properties in desirable way;

A further advantage of the present invention said, that technique of substrate surface preparation, including thermal treatment of substrate is provided to remove moisture, oxygen residues and unwanted debris;

A further advantage of the present invention said, that technique of processing cathode material—Ca, loaded in the hermetic container with inert gas (for example—Argon), protects Ca from being oxidized;

A further advantage of the present invention said, that technique of changing air in vacuum chamber into inert gas (for example—Argon), enhances brightness, luminance and increases organic electroluminescent display life time;

A further advantage of the present invention said, that technique of thermal treatment of all materials, except Ca, contributes to removal of moisture and unwanted impurities;

Another advantage of the present invention is the vacuum chamber, design of which makes it possible to deposit oxygen-moisture-temperature-sensitive materials in one complete production cycle;

A further advantage of the present invention is chamber's design which makes the chamber more convenient in operation, cleaning, maintenance and secures an easy access to all units;

A further advantage of the present invention said, that vacuum chamber is made of materials non-aggressive to oxygen-moisture-temperature-sensitive materials that precludes saturation of aforesaid materials by atmospheric gases, oxidation and degradation;

It is a further advantage of the present invention that the vacuum chamber contains a movable cartridge with external unit for the continuous transport of the substrate during the vapor thermal deposition process that allows to deposit all materials on the substrate without the need to break the vacuum;

It is a further advantage of the present invention that the vacuum chamber contains a mask shadow system, equipped with partitions that divide shadow mask to hold four and up materials, thus enabling to control uniformity, thickness, and patterning profile of the thin film;

It is a further advantage of the present invention that the vacuum chamber that contains common screen with apertures, where a number of apertures is equal to a number of thermal evaporators as well as to a number of masks that helps to maintain a precise position of the substrate above corresponding materials;

It is a further advantage of the present invention that the vacuum chamber contains separating screens, placed between thermal evaporators. Separating screens serve as a barrier between organic and cathode materials, and prevent any thermal evaporator's material from being mixed with other materials.

It is a further advantage of the present invention that the vacuum chamber contains special netting, designed for Ca thermal evaporator in order to protect the chamber from contamination and to eliminate metal spreading;

It is a further advantage of the present invention that the vacuum chamber contains a custom-made low temperature crucible or crucibles for organic materials based on Pb-free, glass, GE-180 glass, being stable under any temperature changes.

### BRIEF DESCRIPTION OF THE DRAWINGS

FIG. 1 is the scheme of vacuum chamber for implementation of the method of claim 2;

FIG. 2 is the scheme of vacuum chamber for implementation of the method of claim 3;

FIG. 3 is the scheme of vacuum chamber of claim 16 and claim 19;

FIG. 4 is the scheme of vacuum chamber for implementation of the method of claim 4.

FIG. 5 is the structure of multilayered, light-emitting diode display of claim 1;

FIG. 6 is the scheme of technique-substrate surface preparation of claim 9;

FIG. 7 is thermal evaporation sources for organic materials of claim 15;

### DETAILED DESCRIPTION OF THE INVENTION

According to the present invention, vapor thermal deposition as a method of manufacturing multilayered organic light emitting diode display is chosen because organic and organic-metallic materials are volatile, high temperature sensitive and can be easy processed in the vacuum atmosphere. In reference to the preferred embodiment, the method of vapor thermal deposition is performed in the vacuum environment under the pressure 10⁻⁵-10⁻⁷, where molecules of different materials from high temperature tungsten boats and low temperature glass GE-180 crucibles reach the substrate. During vapor thermal deposition, position of movable cartridge with transparent and conductive photostripped patterned substrate is precisely controlled and operated by external unit that allows optimizing substrate position above shadow mask in the chamber.

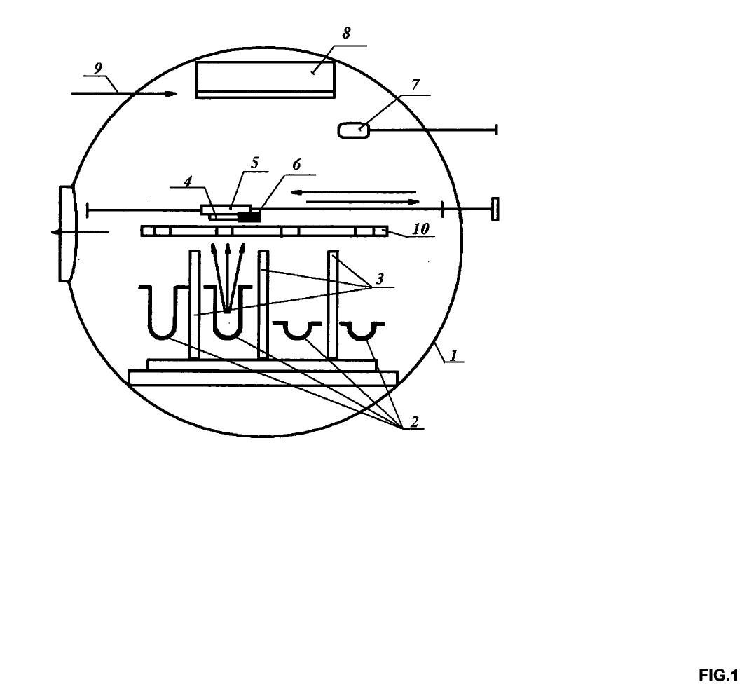

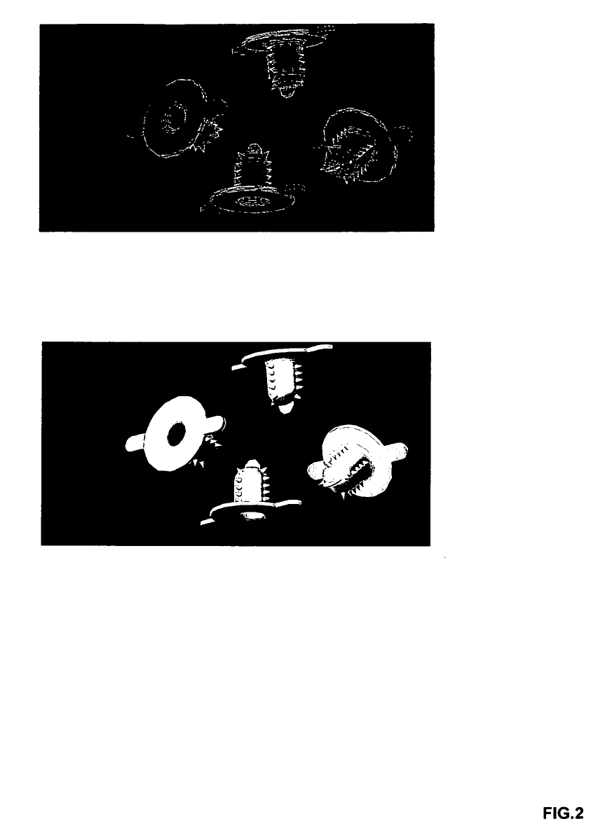

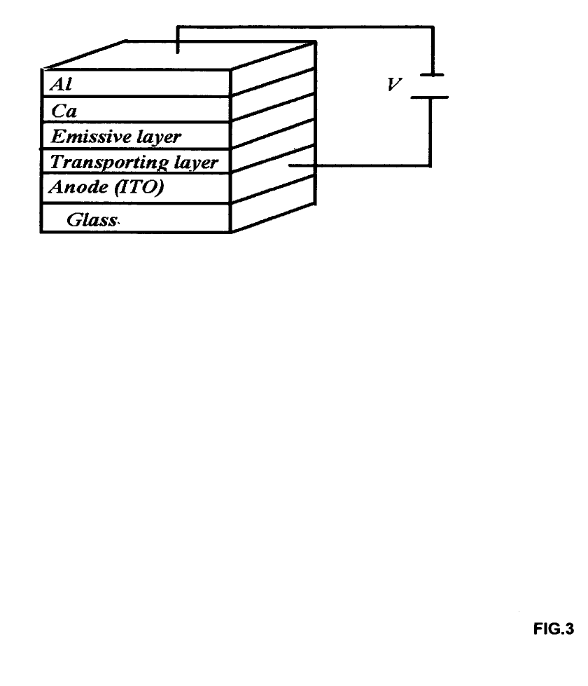

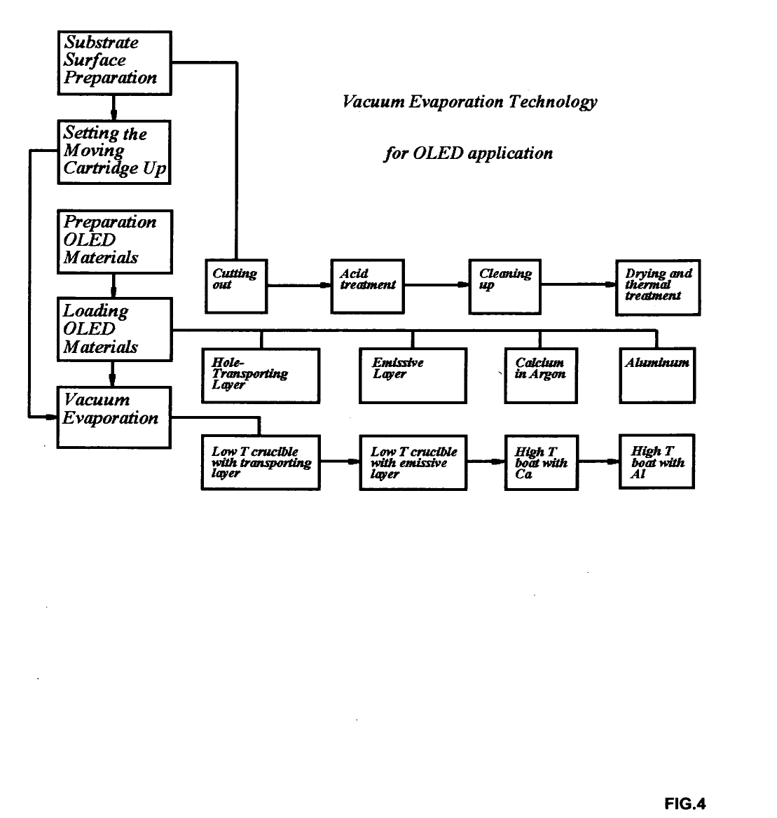

FIG. 1 shows materials evaporation from thermal evaporators to substrate through apertures and masks. In reference to claim 3, number of apertures of common screen is equal to a number of masks (FIG. 2). Common screen with apertures are located above thermal evaporators. FIG. 3 shows that system with shadow mask and movable cartridge with substrate are located above common screen with apertures. In reference to claim 4, number of apertures of common screen is equal to number of thermal evaporators and to number of masks (FIG. 4). Molecules of materials from thermal evaporators reach the substrate without collision with gas molecules in space between the thermal evaporation source and substrate. In reference to the preferred embodiment of claim 1, all materials can still be in the chamber, while production cycle has completed.

In reference to preferred embodiment of the present invention, vapor thermal deposition is achieved by the following operations:

1) Separative screens are loaded between thermal evaporators;
2) Cathode and organic materials are loaded into thermal evaporators and provided into the spaces between screens;
3) Evaporators are heated up: for hole-transporting layer and, for emissive materials ˜380° C., for Ca ˜450° C. for Al ˜900° C.;
4) ITO glass substrate is placed onto the moving cartridge;
5) Movable cartridge with substrate is placed above a mask in the chamber;
6) System is pumping down to the pressure—10⁻⁶ torr;
Vapor thermal deposition provides vacuum evaporation of: hole-transporting layer with evaporation rate: ˜6-15 A/sec and time of deposition: ˜150 sec; emissive layer with evaporation rate: ˜6-5 A/sec and time of deposition: ˜350 sec; Ca (cathode) with evaporation rate: ˜2-6 A/sec and time of deposition: ˜450 sec; and Al (cathode) with evaporation rate: ˜2-6 A/sec and time of deposition: ˜250 sec.

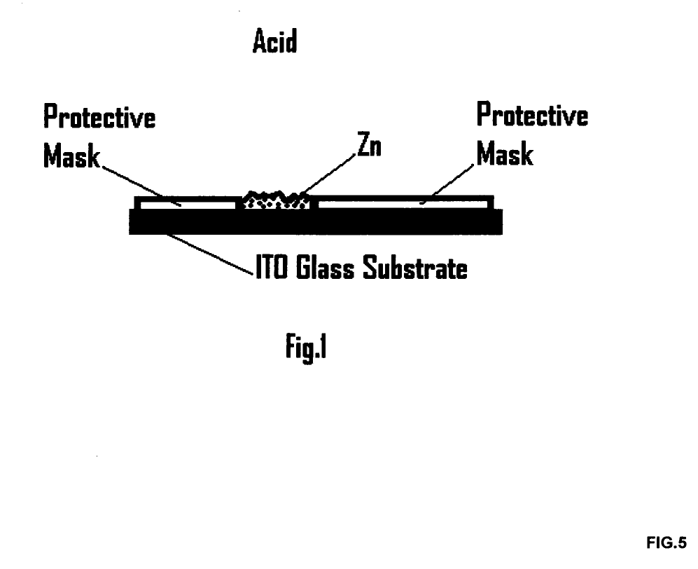

FIG. 5 shows multilayered structure, provided by method of vapor thermal deposition, where the first layer, said first layer comprising a transparent substrate; the second layer, said second layer being hole transporting layer; the third layer located between said second layer and said fourth layer; the third layer comprising at least one organic molecule compound; the fourth layer, located between said third and said fifth layer; the fourth layer, said fourth layer being a cathode with metal-calcium; and the fifth layer, said fifth layer, located on the top of device; the fifth layer, said fifth layer being a cathode with metal-aluminum. When electrical current is passing through the whole stack, bright emission is being obtained.

The first material is transparent glass, preferably for present application, is aluminosilicate glass with composition 55.0% SiO₂, 7.0% B₂O₃, 10.4% Al₂O₃, 21.0% CaO, and 1.0% Na₂O. Indium Tin Oxide (ITO) is transparent and sputtered onto a glass layer for the injection of holes. ITO coats one surface with Rs-4-8 ohm/square, 25×50×1.1 mm. ITO works in the present invention as an anode of ˜50 nm thickness, optical transmission of >85% in the visible spectrum and resistance ˜5 ohm/square;
Next material is an organic monomer from aromatic materials with chemical formula: C₄₄H₃₂N₂ and molecular weight—588.76, melting point—279-281° C., and serves at the present invention, as a hole transporting layer. The hole transporting layer is ˜17.5 nm thick with light emitting potential—5V under 40 lux, and 6V—under 3600 lux;
The third, emissive material—at least one aromatic compound, is ˜35 nm thick with light emitting potential—5V under 40 lux, and 6V—under 3600 lux. Emissive layer is a small organic molecule in crystalline phase, formed during vapor deposition. Aromatic molecules enhance chemical stability to compare with similar non-aromatic molecules because their resonant forms could match the system's natural frequency of vibration. The emissive material, in the present invention, presents several luminescent compounds of polycyclic aromatic hydrocarbons and small organic dye molecules for an electroluminescent device. The emissive layer is also preferably a mixture layer. In the mixture layer, organic compounds are incorporated into the above mixture layer advantageously and lifetime of the device increases. The compound is the electron transporting layer in the present invention. Emissive layer is preferred to be used as a metal complex. This type of bonding between a metal and an organic molecule create a stable compound. The compound of organic-metal complex is preferably selected from fluoranthene derivates, including metal complex of fluoranthene molecule with extended aromatic unit, property to adsorb light in the visible range, and intense blue-green beautiful color. It is also make them promising as dyes in emitting device. As the compound for light emission, it is preferred to use anthraquinone derivates, having excellent brightness and transparency. As a compound capable of intensive fluorescence and having excellent brightness and transparency, it is preferred to use complex materials, containing insoluble azo dyes derivates that belong to red azo dyes derivates with good stability under light, heat and acid. In the present invention, most suitable structure of emitting layer is made by using host and guest materials because of self packing effect between molecules.

Method of manufacturing multilayered organic light emitting diode display provides cathode materials, where optimum compound is pure calcium (Ca—99, 98%), neutral to organic materials reciprocity and pure aluminum (Al—99, 9%), protecting ca from moisture and oxygen degradation. Cathode materials have been deposited from different thermo evaporators onto ITO glass substrate where calcium is ˜30 nm thick with light emitting potential—5 v under 40 lux, and 6 v—under 3600 lux and Aluminum as protective layer with electricity conductive properties, is ˜35 nm thick with light emitting potential—5 v under 40 lux, and 6 v—under 3600 lux.

Cathode compound, according to the present invention, reduces expenditures required for organic light emitting diode display manufacturing due to the fact that costly process of cathode alloy manufacture is no longer relevant.

For Example: Cathode-alloy, consisting Ca 20% and Al 80%, of thickness—200 nm.
Ca and Al have been deposited separately via different evaporators, the best performance of the device was observed, when hole-transporting layer has been added. Emission was observed at U—6 v in the dark, and at U—12 v in daylight (12 PM).

### EXAMPLE 1

Hole-transporting layer-of thickness—10 nm;
Emissive layer of thickness—35 nm;
Cathode: Ca is 30 nm-thick Al—35 nm.
Results: Emission is observed at U—6 v in the dark. Emission is observed in daylight at—U—9 v.

### Conclusion:

Thickness of the Hole-Transporting layer should be decreased.

### EXAMPLE 2

Hole-transporting layer is 7.5 nm thick;
Emissive layer of thickness—355 nm;
Cathode: Ca is 30 nm-thick and Al—35 nm.
Results: emission is nonexistent.

### Conclusion:

Thickness of hole-transporting layer should be increased.
Thickness of emissive layer should be decreased.

### EXAMPLE 3

Hole-transporting layer of thickness—12.5 nm;
Emissive layer of thickness—15 nm;
Cathode: Ca is 30 nm-thick and Al—35 nm.
Results: emission is observed at U—6 v in the dark.
Emission is observed in daylight at—U—9 v.

### Conclusion:

Thickness of the hole-transporting and emissive layers should be increased.

### EXAMPLE 4

Hole-transporting layer of thickness—17.5 nm;
Emissive layer of thickness—35 nm;
Cathode: Ca is 30 nm-thick and Al—35 nm.
Results: Emission is observed at U—5 v in the dark.
Emission is observed in daylight at—U—6 v.

### Conclusion:

Thickness of the hole-transporting layer should be increased.

### EXAMPLE 5

Hole-transporting layer of thickness—25 nm;
Emissive layer of thickness—35 nm;
Cathode: Ca is 30 nm-thick and Al—35 nm.
Results: Emission is observed at U—9 v in the dark.
Emission is observed in daylight at—U—15 v.

### Conclusion:

Thickness of the hole-transporting layer should be decreased.

### EXAMPLE 6

Hole-transporting layer of thickness—17.5 nm;
Emissive layer of thickness—35 nm;
Cathode: Ca is 30 nm-thick and Al—35 nm.
Results: Emission is observed at U—5 v in the dark (40 lux).
Emission is observed at—U—6 v in daylight (3600 lux).

### Conclusion:

The maximum emission of multilayered organic electroluminescent device has been obtained at U—5 v under 40 lux and U—6 v under 3600 lux, when thickness of the hole-transporting layer is 17.5 nm, emissive layer—35 nm, cathode layers: Ca—30 nm and Al—35 nm; voltage of about 6-12 volts is sufficient to drive enough current to cause a very bright emission.

In accordance with the first preferred embodiment of the present invention, the method preferably comprises the following techniques:
1. Substrate surface preparation, including thermal treatment of substrate;
2. Thermal treatment of all materials, except Ca, at t˜150°-170° C., during 30 min;
3. Processing cathode material—Ca in argon atmosphere;
4. Filling of vacuum chamber up with Argon when operation in the vacuum environment has been completed.

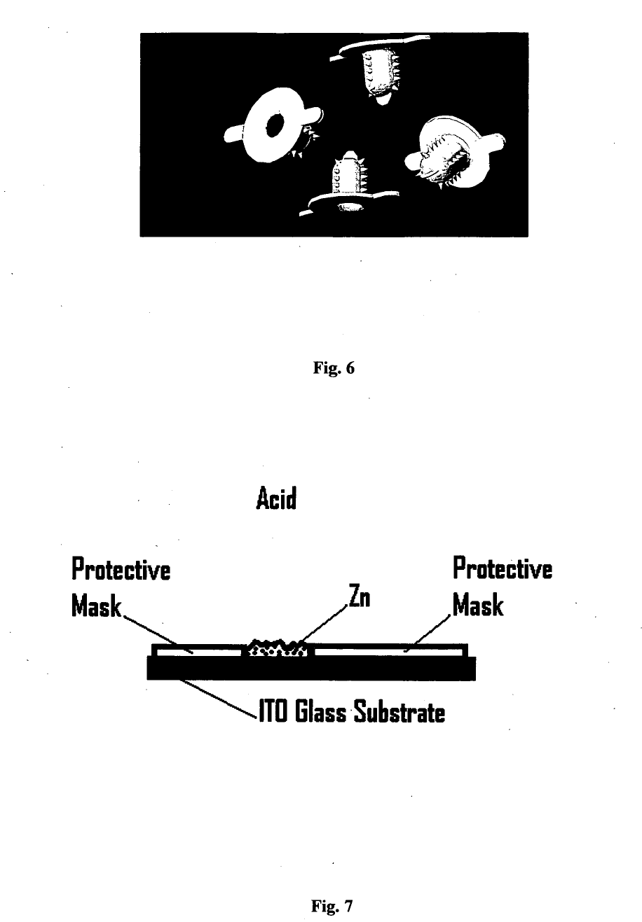

FIG. 6 shows technique-substrate surface preparation and its surface modification for patterning film. The ITO film having a lift-off mask under those areas to be removed and a resistant protective mask over the remaining areas, provides more positive delineation of thin film device pattern. In order to obtain surface properties and receive a reproducible surface, preparation of the ITO-glass substrate has been focused on the surface of the substrate, which must be consistent from substrate to substrate if reproducible film properties are to be attained. In accordance with the preferred embodiment of the present invention, the surface preparation technique does not require photolithography and complies with small molecule organic thin film requirements.

Therefore, ITO substrate surface preparation consists of the following steps:
Cutting edges of ITO Glass in designed dimensions;
Providing material for resistant mask to protect substrate from degradation;
Placing protective mask on coated ITO side of the substrate in multiple step process precisely in alignment strips and pattern desired;
Spreading Zinc powder (pure Zn—99%) on the remaining part of the substrate, where mask is lift-off for modifying selected surface to combine holes.
   To modify selected surface features, Zn-coated part of the substrate is exposed to hydrochloric acid. Process of removing structurally changed portion of substrate consists of the following steps:
Rinsing by distillated water alkaline solvents (NaOH);
Drying throughout by using a high-vapor-pressure alcohol (C₂H₅OH) to prevent any residues on the surface;
Thermal treatment of the substrate in the oven in order to outgas absorbed water and solvent at T—170° C. during 30 min.
   Thermal treatment of substrate in this fashion reduces the presence of moisture on the surface of the substrate, thus providing better adhesion of the resist coating. Therefore, ITO layer now has dielectric holes under those areas that are to be removed and a resistant protective mask over the remaining areas. Hence, an etching process follows; the material under the hole is removed, while the remaining areas are not etched. For that reason, our material resists etching. Thus, the material of the present invention-product is based on polyvinyl chloride (PVC) and its copolymers, being rubber-based, pressure sensitive, and adhesive. The material used is ultimately to be patterned on a particular substrate, its thickness and other properties are important with respect to the end product of the fabrication of organic electroluminescent device. Additional advantages and modifications will readily occur to those skilled in the art. Therefore, the invention in its broader aspects is not limited to the specific details, representative devices, and illustrated examples shown and described herein;

All materials, before loading into thermal evaporators, undergo thermal treatment in the oven, T˜150°-170° C. during 30 min., in order to remove oxygen residues, moisture and unwanted debris;

Calcium being in hermetically sealed container, which is filled by inert gas (argon) has been measured and loaded into thermal evaporator. Pure Ca in argon atmosphere is used to prevent the metal from attack by air, that is a preferable way of thermal vapor deposition technique of oxygen-moisture-temperature-sensitive materials during one production cycle, without recharging of evaporative materials (absence of oxygen reduction during the deposition process).

Thermal evaporator for Ca is a high temperature tungsten boat with high resistance at the notches causing those areas to be hotter than other parts. Tungsten boat is supplied with special netting in order to prevent metal spreading and mixture with others elements of the chamber;

In accordance with the preferred embodiment of the present invention, the vacuum chamber is filling with inert gas (argon) when operation in the vacuum environment has been completed. This method helps to increase life time and improve brightness of light emitting diode device;

Referring to the second preferred embodiment of the present invention, the method of manufacturing multilayered organic light emitting diode display provides vacuum chamber for processing oxygen-moisture-temperature-sensitive materials. FIG. 2 shows a schematic view of an apparatus, said, vacuum chamber for carrying out the method of the present invention that includes: 1 thermal evaporators for different materials; 2 separating screens between thermal evaporators; 3 common screen with apertures; 4 movable cartridge with substrate, and, respectively, a mask holder, equipped with mask partitions; 5 all chamber's elements are made of materials non-aggressive to different materials described above; Vacuum chamber, also, includes device for material's thickness measurement; a vacuum generator, pumping system, consisting of rotary-mechanical pump and ancillary diffusion vacuum pump; input for protective gas (Argon) and thermal evaporators: low temperature crucibles for organic materials and high temperature boats—for cathode materials. Design of vacuum chamber contributes to deposition without reloading materials within production cycle.

Thermal evaporation sources are independently activated by external power switches that give possibility to select regime and adjust time of vapor deposition of each material. Therefore, it precludes organic and metallic materials from overheating and optimizes evaporation ratio of each material. Thermal evaporators for different materials are high temperature boats for cathode materials and low temperature crucibles for organic materials;

In reference to FIG. 7, thermal evaporation sources for organic materials are low temperature evaporation sources based on glass GE-180 and chosen by virtue of its capacity to prolong the crucible service duration.

All thermal evaporation sources are mounted on a rigid stand and separated by stainless steel screens that serve as a barrier between organic and metallic molecules in order to prevent degradation of organic molecules and undesirable transferring relationship between molecules.

Movable cartridge with substrate has an external unit to optimize position of the substrate above corresponding mask. Manually operated movable cartridge allows the substrate to be placed in a preferable position; to be moved on an even plane respectively to each layer in designed direction; and to deposit all materials on the substrate without reloading materials. Movable cartridge with substrate is located above mask shadow. Immobile mask shadow has partitions to divide mask in the parts that correspond to each material. Arrangement parts of the mask shadow for different materials are presented in the following sequence: 1st—mask for material, served as a hole-transporting layer, 2nd—mask for material, served as an emissive layer, 3rd—mask for material, served for calcium and 4th—mask for material, served for aluminum.

Referring to claim 13 of the present invention, all chamber's elements are made of stainless steel with large amounts of chromium and nickel being added to inhibit corrosion (density—0.289 lb/in³ heat capacity—0.12 btu/lb and melting point—2550-2650° F.).

1. Manufacturing multilayered organic light emitting diode display is a method of vapor thermal deposition of different materials that are oxygen-moisture-temperature-sensitive during one production cycle;

2. The method of claim 1 provides vapor thermal deposition of different materials, where all materials are evaporated through corresponding apertures and shadow mask to a substrate, and the substrate is precisely positioned above a proper mask by external unit of movable cartridge;

3. The method of claim 1 provides vapor thermal deposition of different materials, where all materials are evaporated through apertures of common screen and different masks of a shadow mask to substrate, where number of apertures is equal to a number of different masks;

4. The method of claim 1 provides vapor thermal deposition of different materials, where all materials are evaporated from thermal evaporators through apertures of common screen and different masks of shadow mask to substrate, where a number of apertures is equal to a number of thermal evaporators and to that of different masks;

5. The method of claim 1 provides materials that are evaporated to the substrate with maximum emission at U—5V under 40 lux and U—6V under 3600 lux, when thickness of the hole-transporting layer is 17.5 nm, emissive layer—35 nm, cathode layers: Ca—30 nm and Al—35 nm;

6. The method of claim 1 provides emissive layer, which is at least one organic small molecule aromatic compound, preferably selected from fluoranthene derivates, being ˜35 nm-thick with light emitting potential—5V under 40 lux, and 6V—under 3600 lux;

7. The method of claim 1 provides cathode materials—calcium (Ca) and aluminum (Al), deposited from different thermal evaporators, where Al protects Ca from moisture and oxygen degradation;

8. The method of manufacturing multilayered organic light emitting diode display of claim 1, comprises techniques of processing different materials that are oxygen-moisture-temperature-sensitive during one production cycle;

9. The method of claim 8 for vapor thermal deposition of oxygen-moisture-temperature-sensitive materials comprises technique of substrate surface preparation with thermal treatment of substrate;

10. The method of claim 8 comprises technique of processing cathode material—Ca being place in atmosphere of inert gases, for example: argon;

11. The method of claim 8 comprises thermal treatment technique for all materials, except Ca, in order to remove moisture and impurities;

12. The method of claim 8 comprises technique of filling vacuum chamber with inert gas, for example: argon, when deposition process has been completed;

13. The method of claim 2 provides vapor thermal deposition of different materials via vacuum chamber that includes: a) 4 and up independently activated thermal evaporators for different materials; b) common screen with apertures; c) separative screens between thermal evaporators; d) movable cartridge with substrate; e) mask shadow equipped with mask partitions, f) all chamber's elements are made of materials non-aggressive to different materials described above;

14. The method of claim 13 provides vacuum chamber that includes special netting for Ca thermal evaporator that prevents metal from spreading during the process of evaporation;

15. The method of claim 13 provides vacuum chamber that includes thermal evaporators for organic materials, based on glass GE-180;

16. The method of claim 13 provides vacuum chamber that includes common screen with apertures located above thermal evaporators;

17. The method of claim 13 provides vacuum chamber that includes stainless steel separating screens located between thermal evaporators;

18. The method of claim 13 provides vacuum chamber that includes a movable cartridge with external unit for continuous transport of the substrate during the vapor thermal deposition;

19. The method of claim 13 provides vacuum chamber that includes mask shadow with different masks located above common screen with apertures;

20. The method of claim 13 provides vacuum chamber that includes system of mask shadow, equipped with mask partitions that divide shadow mask to hold four and up materials.
